(19) United States
(12) Patent Application Publication
(10) Pub. No.: US 2007/0094065 A1
(43) Pub. Date: Apr. 26, 2007

(54) Activity planning method and system

(76) Inventors: Chenghsiu Wu, Sunnyvale, CA (US); Jiunjie Liau, San Jose, CA (US); Yi-Ming Tseng, Palo Alto, CA (US)

Correspondence Address: CHENGHSIU WU, 362 PESCADERO TERRACE, SUNNYVALE, CA, 94086, US

(21) Appl. No.: 11/584,081

(22) Filed: Oct. 20, 2006

Related U.S. Application Data
(60) Provisional application No. 60/729,883, filed on Oct. 24, 2005.

(51) Int. Cl. G06F 15/02

(52) U.S. Cl. 705/9

(57) ABSTRACT

A computer-implemented method for planning an activity is disclosed. The method includes receiving a suggestion pertaining to the activity from an initiator and receiving a list of invitees, the list of invitees including at least two invitees. The method further includes executing a decision program, using input data, to generate an activity plan. The input data includes at least one of initiator preference data pertaining to preferences of the initiator and invitee preference data pertaining to preferences of at least one of the invitees. The activity plan includes at least one of a list of suggested participants for the activity, a recommended time slot for the activity, and a recommended location for the activity.

### PRIORITY CLAIM

This application claims the benefit of U.S. Provisional Application No. 60/729,883 which was filed on Oct. 24, 2005 and which is incorporated herein by reference.

### TECHNICAL FIELD OF THE INVENTION

One or more embodiments of the present invention relate to a method for planning, and more particularly, a method for planning activities involving multiple entities (possible participants).

### BACKGROUND OF THE INVENTION

Group events (or activities) with friends, colleagues, and/or family, such as dinner, ball games, hiking, camping, parties, etc., may be important to many people. However, coordinating the events and/or activities may be a time-consuming task.

Conventional online invitation services may be useful when the time and location of an event (or activity) are fixed and when the coordinator of the event wishes to have an easy way to handle RSVP and a centralized place to communicate with all invitees. This is the case when the event is a conference, a wedding ceremony, or a trade show. For other activities or events such as, for example, business meetings, lunch plans, golfing, for which one or more of the ‘who’, ‘where’, and ‘when’ may be flexible, conflicts may occur and an activity coordinator may not have a quick and easy way to form plans that satisfy the most interest of most people. For example, it may be common for co-workers to stand outside the company building debating which restaurant to go for lunch, and this is a simple case where only the ‘where’ is not determined. In other more complicated cases such as, for example, a golfing event, all three variables (who, where, and when) may need to be determined. Each member in a group of people may have different preferred courses as well as different time slots that he or she can play golf during a week. Some would like to play but can also skip for the week if there is already a four-some. It may be very difficult for a coordinator to handle all these inputs manually while making most people in the group happy. This may involve many phone calls and back-and-forth emails and may result in a less-than-desirable plan and a very frustrated coordinator. In some even more complicated cases, even ‘what’, or the nature of the activity, needs to be determined. For example, when a friend will visit and will stay for a week, there may be options regarding what to do in the gathering such as lunch, dinner, golf, hiking, etc.

### SUMMARY OF THE INVENTION

An embodiment of the present invention involves a computer-implemented method for planning an activity. The method includes receiving a suggestion pertaining to the activity. The suggestion may be provided by an initiator. The suggestion may include at least one of a location, a time window, an estimated duration, and a message pertaining to the activity. The method may also include receiving a list of invitees. In one or more embodiments, the list of invitees includes at least two invitees. An invitee may represent an entity that is invited by the initiator and/or an entity that expresses interest in attending the activity after knowing about the activity. The method may further include receiving initiator preference data. The initiator preference data may include data pertaining to the initiator's attitude toward at least one of the invitees. The method may further include notifying the invitees of the suggestion. The method may further include receiving invitee preference data. The invitee preference data may include data pertaining to at least one invitee's attitude toward at least one of possible participants of the activity. The at least one invitee is among the invitees. The possible participants of the activity may include the initiator and the invitees (and one or more guests invited by one or more of the invitees). The method may further include executing a decision program, using input data, to generate an activity plan. The input data may include the initiator preference data and the invitee preference data. The activity plan may include a list of suggested participants for the activity.

One or more embodiments of the present invention involve an article of manufacture comprising a program storage medium configured to store computer readable code for planning an activity. The computer readable code may be configured to receive a suggestion pertaining to the activity. The suggestion may be provided by an initiator. The suggestion may include at least one of a location, a time window, an estimated duration, and a message pertaining to the activity. The computer readable code may be configured to receive a list of invitees. An invitee may represent an entity that is invited by the initiator and/or an entity that expresses interest in attending the activity after knowing about the activity. The computer readable code may be configured to receive initiator preference data. The initiator preference data may include data pertaining to the initiator's attitude toward at least one of the invitees. The computer readable code may be configured to notify the invitees of the suggestion. The computer readable code may be configured to receive invitee preference data. The invitee preference data may include data pertaining to at least one invitee's attitude toward at least one of possible participants of the activity. The at least one invitee is among the invitees. The possible participants of the activity may include the initiator and the invitees (and one or more guests invited by one or more of the invitees). The computer readable code may be configured to execute a decision program, using input data, to generate an activity plan. The input data may include the initiator preference data and the invitee preference data. The activity plan may include a list of suggested participants for the activity.

### BRIEF DESCRIPTION OF THE DRAWING

FIG. 1 shows a system in accordance with one or more embodiments of the present invention for planning an activity.

FIG. 2 is a flowchart of a method in accordance with one or more embodiments of the present invention (which, for example and without limitation, utilizes the system shown in FIG. 1) for planning an activity.

FIG. 3 is a flowchart of a method in accordance with one or more embodiments of the present invention (which, for example and without limitation, utilizes the system shown in FIG. 1) for planning an activity.

FIG. 4 is a flowchart of a method in accordance with one or more embodiments of the present invention (which, for example and without limitation, utilizes the system shown in FIG. 1) for planning an activity.

FIG. 5A shows a user interface for receiving an activity suggestion in accordance with one or more embodiments of the present invention.

FIG. 5B shows an interactive calendar for receiving one or more time slots in accordance with one or more embodiments of the present invention.

FIG. 5C shows a user interface for receiving information pertaining to locations and people (participle participants) in accordance with one or more embodiments of the present invention.

FIG. 5D shows a user interface for receiving preference data including data pertaining to time, locations, and people in accordance with one or more embodiments of the present invention.

FIG. 5E shows a user interface for presenting status of activity (or event) planning and/or an activity (or event) plan in accordance with one or more embodiments of the present invention.

FIG. 5F shows a user interface for a user to manage activities (or events) in accordance with one or more embodiments of the present invention.

### DETAILED DESCRIPTION

In this document, “activity” and “event” may be used interchangeably.

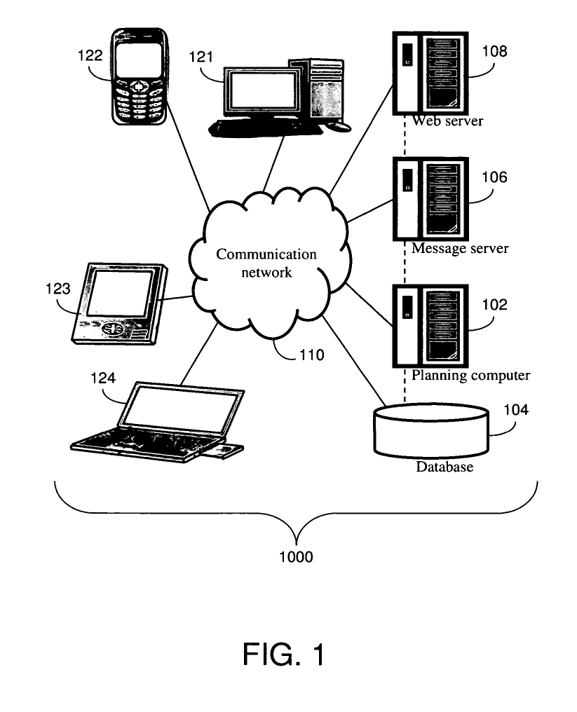

FIG. 1 shows activity planning system 1000 in accordance with one or more embodiments of the present invention. As shown in FIG. 1, activity planning system 1000 may include: database 104; and planning computer 102 (or a computing device) that is connected with communication network 1 10 and database 104.

Planning computer 102 may be configured to receive, through communication network 110, a suggestion pertaining to the activity. The suggestion may be provided by an initiator. The suggestion may include at least one of a location, a time window, an estimated duration, and a message pertaining to the activity.

Planning computer 102 may be further configured to receive, through communication network 110, a list of invitees.

Planning computer 102 may be further configured to receive initiator preference data from at least one of database 104 and the initiator. The initiator preference data may include data pertaining to the initiator's attitude toward at least one of the invitees.

Planning computer 102 may be further configured to notify, through communication network 110, the invitees of the suggestion.

Planning computer 102 may be further configured to receive invitee preference data from at least one of database 104 and at least one invitee. The invitee preference data may include data pertaining to the at least one invitee's attitude toward at least one of possible participants of the activity. The at least one invitee is among the invitees. The possible participants of the activity may include the initiator, the invitees, and guests invited by one or more of the invitees.

Planning computer 102 may be further configured to execute a decision program, using input data, to generate an activity plan (or recommendation). The input data may include the initiator preference data and the invitee preference data. The activity plan may include a list of suggested participants for the activity.

In one or more embodiments, planning computer 102 is further configured to update database 104 with the activity plan.

The initiator preference data may further include at least one initiator-preferred time slot for the activities. The invitee preference data may further include at least one invitee-preferred time slot for the activity. The activity plan may further include a recommended time slot for the activity.

The initiator preference data may further include data pertaining to at least one initiator-preferred location for the activities. The invitee preference data may further include data pertaining to at least one invitee-preferred location for the activity. The activity plan may further include a recommended location for the activity.

The input data further may include at least one of promotion information, price information, provider information, and capacity information pertaining to one or more possible locations for the activity. The input may include a cost limit.

In one or more embodiments, planning system 1000 may include communication network 110. In one or more embodiments, planning system 1000 may further include message server 106 that is adapted to deliver messages and Web server 108 that is adapted to provide a Web user interface. Message server 106 and Web server 108 may enable an activity initiator and invitees to communicate with planning computer 102 through communication network 110.

In accordance with one or more embodiments of the present invention, activity planning system 1000 may include one or more user devices such as, for example and without limitation, personal computer 121, cellular phone 122, personal digital assistant 123, and notebook computer 124 that are used by the initiator and the other entities (e.g., invitees). Conventional hardware and software components and communication protocols and data formats may be used in activity planning system 1000 for user devices 121-124, communication network 110, message server 106, Web server 108, database 104, and planning computer 102. At least one of planning computer and Web server 108 may run a server-side program written in a programming language well known in the art such as, for example and without limitation, ColdFusion, JSP, ASP, or PHP. A user device may run a client-side program written in a programming language that is well known in the art such as, for example and without limitation, AJAX or JavaScript.

In accordance with one or more embodiments of the present invention, planning computer 102 may include a software program that performs an optimization operation based on input data to generate a recommendation for an activity (or an activity plan). The input data may include the initiator preference data and the invitee preference data. The recommendation may include, for example and without limitation, a subject matter of the activity such as, for example and without limitation, ad hoc meeting, golf, or lunch. The subject matter of the activity may be determined based on a recommended location for the activity. Further, the recommendation may include, for example and without limitation, one or more of suggested participants, a recommended time slot, and a recommended location for the activity.

In accordance with one or more embodiments of the present invention, the program is configured to generate the recommendation and generate other recommendations for other activities simultaneously. In accordance with one or more embodiments of the present invention, the software program may include an optimization algorithm using linear or nonlinear programming. In accordance with one or more embodiments of the present invention, communication network 110 may include at least one of a data network, a telecommunication network, and a wireless network. In accordance with one or more embodiments of the present invention, planning computer 102 may include a plurality of distributed computers. In accordance with one or more embodiments of the present invention, database 104 may include a plurality of distributed database. In accordance with one or more embodiments of the present invention, database 104 may be configured to store and relate data concerning the activity and other data concerning other activities.

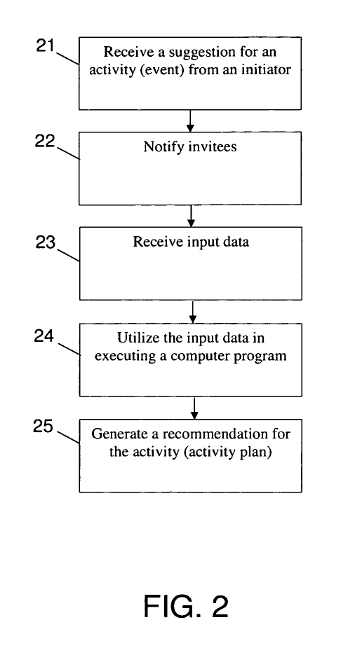

FIG. 2 is a flowchart of a computer-implemented method in accordance with one or more embodiments of the present invention (which, for example and without limitation, utilizes activity planning system 1000 shown in FIG. 1) for planning an activity. One or more embodiments of the present invention may involve an article of manufacture comprising a program storage medium configured to store computer readable code for implementing one or more steps of the method.

The method may include: receiving a suggestion pertaining to the activity from an initiator including a list of invitees; notifying the invitees of the suggestion; receiving input data; utilizing the input data in executing a computer program; and generating a recommendation that is related to the activity. The input data may include initiator preference data and invitee preference data. The initiator preference data may include data pertaining to the initiator's attitude toward at least one of the invitees. The invitee preference data may include data pertaining to at least one invitee's attitude toward at least one of possible participants of the activity. The at least one invitee is among the invitees. The possible participants of the activity include the initiator and the invitees.

The method starts with step 21 (shown in FIG. 2) at which planning computer 102 (shown in FIG. 1) may receive a suggestion for an activity from an initiator through communication network 110 (shown in FIG. 1). The initiator may include a person, a computer, a business, or a corporation. The initiator may provide the suggestion using a user device such as, for example and without limitation, any of user devices 121-124 (shown in FIG. 1). In accordance with one or more embodiments of the present invention, planning computer 102 (shown in FIG. 1) may provide a suggestion template user interface that is adapted to assist (and limit) the initiator in providing the suggestion. The suggestion template may include any of the user interface features that are well known in the art such as, for example and without limitation, one or more Web pages, pull-down menus, radio buttons, and hyperlinks.

In accordance with one or more embodiments of the present invention, the suggestion may include any activity constituent or attribute such as, for example and without limitation, a subject matter, time window, duration, place, inter-personal relation or social group, and/or cost that is relating to the activity. The suggestion may be broad, vague, narrow, or specific. For example and without limitation, the suggestion may include a subject matter of a vaguer “outdoor activity” or a more specific “golf”; the suggestion may include a broader “next month” or a narrower “first Saturday of next month”. The suggestion may include a message pertaining to the activity. Then, control is transferred to step 22 (shown in FIG. 2).

At step 22 (shown in FIG. 2), planning computer 102 (shown in FIG. 1) may notify one or more invitees of the suggestion through communication network 110 (shown in FIG. 1). The invitees are notified through devices such as, for example and without limitation, user devices 121-124 (shown in FIG. 1) and in a way that is based on their profiles stored in database 104 and based on settings of the initiator. In accordance with one or more such embodiments, the one or more invitees may include any of a person, a computer, a business, and a corporation. Then, control is transferred to step 23 (shown in FIG. 2).

At step 23 (shown in FIG. 2), planning computer 102 (shown in FIG. 1) receives input data from the initiator, one or more invitees, and/or database 104 (shown in FIG. 1). In accordance with one or more embodiments of the present invention, planning computer 102 (shown in FIG. 1) may provide an input template user interface that is adapted to assist (and limit) the one or more invitees in providing inputs. The input template may include any of user interface features that are well known in the art such as, for example and without limitation, one or more Web pages, pull-down menus, radio buttons, and hyperlinks. A number of the one or more invitees may choose to provide inputs. In accordance with one or more such embodiments, the inputs may include a constraint such as one that is related to, for example and without limitation, subject matter, location, time, inter-personal compatibility, or cost, and the constraint may include a preference or a limitation. A constraint may include, for example and without limitation, a preference, a limitation, or an assessment. For example and without limitation, a first entity (the initiator or an invitee) may assign a high weight or score to a birthday person for a birthday party; a second entity may have high preference for a first restaurant but low preference for a second restaurant; a third entity may be able to attend an activity on a first date but unable to attend the activity on a second date; and a fourth entity may have high compatibility with a fifth entity (i.e., both of the fourth and fifth invitees may be happier if they both attend the activity than if only one of them is there) and negative compatibility with a sixth entity (i.e., both of the fourth and sixth invitees may be less happy if they both attend the activity than if only one of them is there). Further, In accordance with one or more embodiments of the present invention, the inputs may include product or service-related information such as, for example and without limitation, promotion, cost, or provider. Then, control is transferred to step 24 (shown in FIG. 2),

At step 24 (shown in FIG. 2), planning computer 102 (shown in FIG. 1) may utilize the inputs from step 23 in executing a computer program. In accordance with one or more such embodiments, planning computer 102 may further utilize information stored in database 104 (shown in FIG. 1) in executing the computer program. In accordance with one or more such embodiments, the information includes an assessment, a profile, a prior input, a record (such as an attendance record), or an inter-personal compatibility data of the one or more invitees, or assessments of one or more subject matters, locations, or times. In accordance with one or more embodiments of the present invention, the computer program includes an optimization function. In accordance with one or more such embodiments, the computer program includes an optimization algorithm using linear or nonlinear programming. In accordance with one or more embodiments of the present invention, the computer program is adapted to interact with a commercially available optimization program such as, for example and without limitation, Mathematica of Wolfram Research, Inc. (www.wolfram.com) of Champaign, Ill.; Matlab of The MathWorks, Inc. (www.mathworks.com) of Natick, Mass.; or Excel Solver of Microsoft Corporation (www.microsoft.com) of Redmond, Wash. In accordance with one or more embodiments of the present invention, the computer program may be configured to compare possible results of a plurality of scenarios that incorporate data from the one or more inputs. Then, control is transferred to step 25 (shown in FIG. 2).

At step 25 (shown in FIG. 2), planning computer 102 (shown in FIG. 1) generates a recommendation for the activity, as a result of executing the program in step 24. In accordance with one or more embodiments of the present invention, the recommendation includes any of a subject matter, a participant, a location, or a time for the activity.

The method may further include notifying the entities of the recommendation.

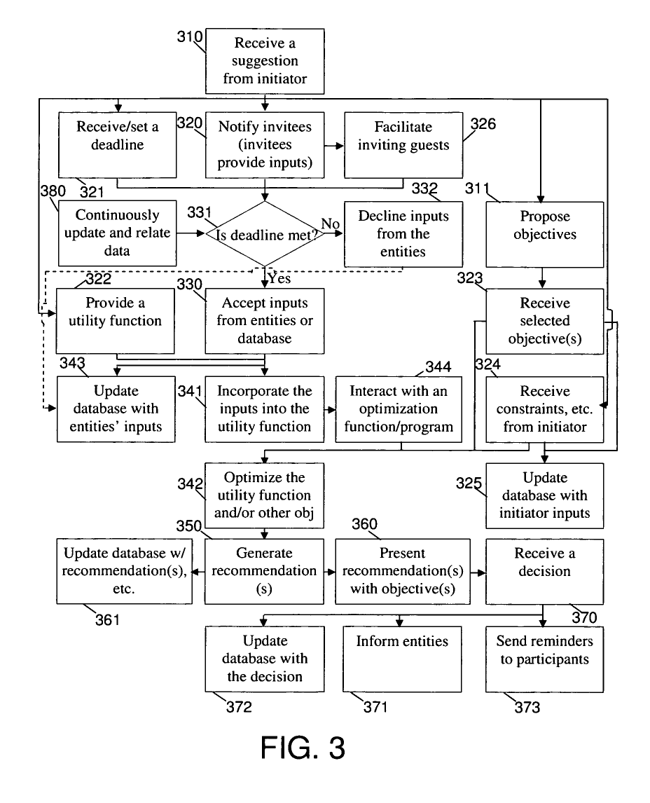

FIG. 3 is a flowchart of a computer-implemented method in accordance with one or more embodiments of the present invention (which, for example and without limitation, utilizes the system shown in FIG. 1) for planning an activity. One or more embodiments of the present invention may involve an article of manufacture comprising a program storage medium configured to store computer readable code for executing one or more steps of the method.

The method may start with step 310, which may be similar to step 21 (shown in FIG. 2) described above. Then, control may be transferred to steps 320, 321, 322, 324, and 311 (shown in FIG. 3).

At step 324, planning computer 102 may receive one or more constraints such as, for example and without limitation, limitations or preference from the initiator. Then, control may be transferred to step 325.

At step 325, planning computer 102 may update database 104 with inputs from the initiator.

At step 311, planning computer 102 may propose one or more objectives for planning the activity for the initiator (and/or one or more invitees) to select from. The one or more objective may include, for example and without limitation, maximizing utility (a balance of considerations) or canned or pre-configured objectives such as, for example and without limitation, maximizing number of participants, minimizing total cost, maximizing total satisfaction of participants, or minimizing dissatisfaction. The objective may represent at least one of maximizing the number of the suggested participants, maximizing an aggregated utility function of the possible participants, maximizing an aggregated utility function of the suggested participants, maximizing an aggregated utility function of the possible participants excluding the suggested participants, minimizing deviation from a maximum aggregated utility value of the possible participants, minimizing deviation from a maximum aggregated utility value of the suggested participants, and minimizing deviation from a maximum aggregated utility value of the possible participants excluding the suggested participants. Then, control may be transferred to step 323.

At step 323, planning computer receives one or more selected objectives from the initiator (and/or one or more invitees). Then, control may be transferred to step 325.

At step 320 (shown in FIG. 3), planning computer 102 (shown in FIG. 1) notifies one or more invitees of the suggestion. In accordance with one or more embodiments of the present invention, step 320 may be similar to step 22 (shown in FIG. 2) described above. Then, control may be transferred to steps 326 and 331 (shown in FIG. 3).

At step 322 (shown in FIG. 3), planning computer 102 (shown in FIG. 1) may provide a utility function based on consideration of data including, for example and without limitation, a profile of the initiator, a record of the initiator, or a profile of a group of invitees. In accordance with one or more embodiments of the present invention, planning computer 102 may guide the initiator to further provide one or more inputs and forms a utility function taking into account the one or more inputs. The one or more inputs may include preferences, priority assessment, and/or assigning scores or weights pertaining to the one or more invitees (and guests), subject matters, time slots, or locations. Then, control may be transferred to step 341 (shown in FIG. 3).

At step 326 (shown in FIG. 3), planning computer 102 (shown in FIG. 1) may facilitate the one or more invitees to invite one or more guests. Then, control may be transferred to step 331 (shown in FIG. 3).

At step 321 (shown in FIG. 3), planning computer 102 (shown in FIG. 1) may set a deadline for accepting inputs in response to a setting by the initiator or to an automatic analysis of timing of one or more constituents or attributes in the suggestion such as, for example and without limitation, subject matter, time, place, inter-personal relation or social group, and/or cost. For example and without limitation, planning computer 102 may set a deadline taking into account show dates of an opera. Then, control may be transferred to step 331 (shown in FIG. 3).

At step 380 (shown in FIG. 3), database 104 (shown in FIG. 1) may continuously update and relate data from various sources such as, for example and without limitation, the initiator and the one or more invitees (and guests from step 326 shown in FIG. 3), other initiators and other invitees of other activities, and other sources such as, for example and without limitation, news agencies, event planners, etc. Then, control may be transferred to step 331 (shown in FIG. 3).

At step 331 (shown in FIG. 3), planning computer 102 may determine whether to accept inputs based on whether the deadline is met, i.e., whether the inputs are received by the deadline. If the deadline is met, then control may be transferred to step 330 (shown in FIG. 3); if the deadline is not met, then control may be transferred to step 332 (shown in FIG. 3).

At step 332 (shown in FIG. 3), planning computer 102 (shown in FIG. 1) declines late inputs that are received after the deadline and notify providers of the late inputs of declination through communication network 110. In accordance with one or more embodiments of the present invention, control may be then transferred to step 343 (shown in FIG. 3).

At step 330 (shown in FIG. 3), planning computer 102 (shown in FIG. 1) accepts inputs received by the deadline from the one or more invitees (and guests). Further, planning computer 102 may extract data from database 104 (shown in FIG. 1). The inputs may include invitee preference data. The invitee preference data may include data pertaining to attitudes toward other possible participants (e.g., the initiator and other invitees) of the activity, possible time slots for the activity, preferences regarding possible time slots for the activity, possible locations for the activity, and/or opinions regarding possible locations for the activity. Then, control may be transferred to steps 341, and 343 (shown in FIG. 3).

At step 343 (shown in FIG. 3), planning computer 102 (shown in FIG. 1) may update database 104 (shown in FIG. 1) with the one or more inputs that are accepted. In accordance with one or more embodiments of the present invention, planning computer 102 may also update database 104 with inputs that are declined.

At step 341, planning computer 102 may incorporate the inputs received at step 330 into the utility function provided at step 322. Then, control may be transferred to step 344.

At step 344, planning computer 102 may call and/or interact with an optimization function or an optimization program. Then, control may be transfer to step 342.

At step 342, planning computer 102 may optimize the utility function and/or other selected objectives by running the optimization function or program called in step 344. Then, control may be transferred to step 350.

At step 350, planning computer 102 may generate one or more recommendations corresponding to the selected objectives through optimization performed in step 342. The one or more recommendations may include one or more lists of suggested participants for the activity, one or more recommended time slot for the activity, and/or one or more recommended location for the activity. Then, control may be transferred to steps 361 and 360.

At step 361, planning computer 102 updates database 104 with the recommendations and their corresponding objectives.

At step 360, planning computer 102 may present recommendations for the activity along with the selected objectives to the initiator (and one or more invitees). For example, given that objectives of maximizing utility and minimizing total dissatisfaction, planning computer 102 may present two different recommendations that corresponding to the above objectives, respectively, such as: (a) to maximize utility: invite only Earl Birdy, golf at the Ranch Golf Course on Thu 5:30 am; (b) to minimize aggregated dissatisfaction: invite Adam, Cathy, and Dennis, golf at Palo Alto Golf Course on Sat 10 am. Then, control may be transferred to step 370.

At step 370, planning computer 102 may receive a decision for the activity from the initiator (and/or other related invitees) for finalizing the planning. The decision may be selected from the one or more recommendations. The initiator may also override the one or more recommendations. Then, control may be transferred to steps 371, 372, and 373.

At step 372, planning computer 102 may update database 104 (shown in FIG. 1) with the decision.

At step 371, planning computer 102 may inform the one or more invitees (and guests) of the decision for the activity.

At steps 373, planning computer 102 may send reminders to would-be participants of the activity at appropriate time(s).

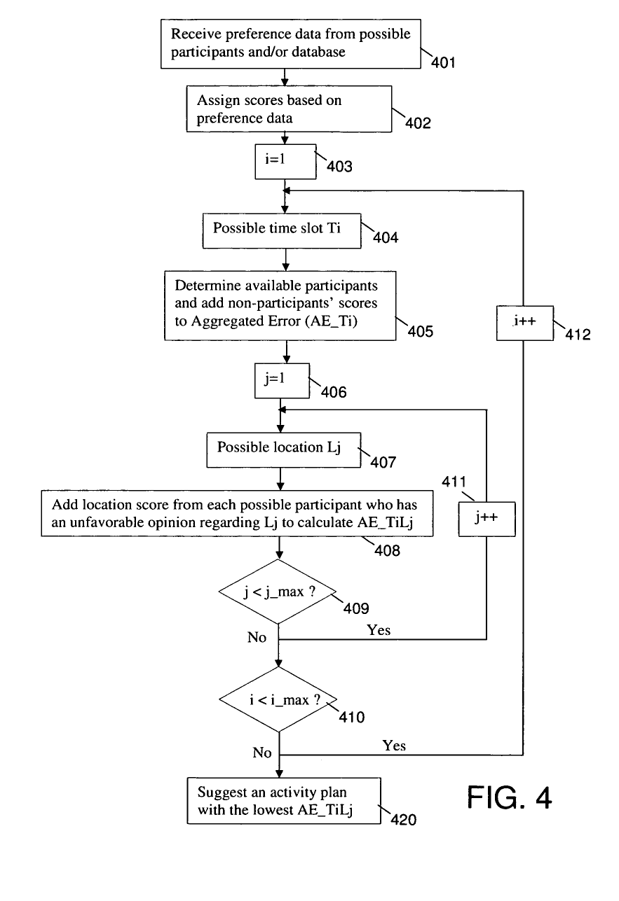

FIG. 4 is a flowchart of a method in accordance with one or more embodiments of the present invention (which, for example and without limitation, utilizes activity planning system 1000 shown in FIG. 1) for planning an activity. The method may work under multiple possible participants' constraints and may minimize deviation from the possible participants' preferences, thereby minimizing total dissatisfaction for the activity.

In one or more embodiments, the method may involve going through all potential scenarios (potential activity plans). For each potential scenario, a planning computer such as, for example, planning computer 102 shown in FIG. 1, may calculate an accumulated score for the potential scenario. Then, the planning computer may calculate deviation of the score for the potential scenario from a maximum score. The maximum score may be calculated by accumulating scores of individually most preferred scenarios of all of the possible participants. The potential scenario with the lowest deviation may be the one that satisfies most possible participants' preferences or provides the highest aggregate satisfaction (or the lowest aggregate dissatisfaction) for the possible participants.

At step 401, a planning computer such as, for example, planning computer 102 shown in FIG. 1, may receive preference data from possible participants (including the initiator of the activity and the invitees) and/or a database such as, for example, database 104 shown in FIG. 1.

At step 402, based on the preference data, the planning computer may give each possible participant a weighting score (participant score, PS) that represents the suitability and/or importance of this entity's presence in this activity. For example, a possible participant that is liked by many other possible participants may be given a high score; a possible participant that is disliked by many other possible participants may be given a low score. Further, for example, a send-off party for Jason will be meaningless if Jason could not make it; as such, Jason may be identified as a priority possible participant and may be given an extremely high score. Possible participants who expressed strong intention to participate may also be given high scores. Similarly, other decision variables for the activities such as, for example, possible locations selected from database 104 and/or input by the possible participants may also be given scores (location scores, LS) based on the preference data.

The method may include two loops: one may go through possible time slots, and the other may go through possible locations. At any given point in time, there may be a group of possible time slots entered by the possible participants.

At step 403, the planning computer may set time slot index equal to 1.

At step 404, the planning computer may identify time slot Ti.

At step 405, for each time slot Ti, the planning computer may identify a corresponding list of possible participants who can make it. A variable defined as AE (aggregated error) may be calculated for each Ti based on the summation of the PS (participant scores) for all potential participants that could not make the time slot Ti. An aggregate error (or deviation) for time slots, AE_Ti, may be calculated.

$$AE\_Ti = {\sum }_{i}^{} PS ( Ti )$$

Then, the planning computer may loop through each possible location Lj and add any deviation score to AE_Ti.

At step 406, the planning computer may set location index j equal to 1.

At step 407, the planning computer may identify possible location Lj.

At step 408, the planning computer may Add location score from each possible participant who has an unfavorable opinion regarding Lj to AE_Ti to calculate an aggregate error (or deviation) for time slots and locations, AE_{‘}TiLj, which may represent a utility function.

$$AE\_TiLj = AE\_Ti + {\sum }_{j}^{} LS ( Ti , Lj )$$

At step 409, the planning computer may determine whether all possible locations have been taken into account (e.g., exhausted) in calculating AE_TiLj by checking whether location index j is less than j_max, which represents the number of possible locations. If j is less than j_max, control is transferred to step 411, at which location index j is incremented by 1, and then control is transferred back to step 407. If j is not less than j_max, control is transferred to step 410.

At step 410, the planning computer may determine whether all possible time slots have been taken into account (e.g., exhausted) in calculating AE_TiLj by checking whether time slot index i is less than i_max, which represents the number of possible time slots. If i is less than i_max, control is transferred to step 412, at which location index i is incremented by 1, and then control is transferred back to step 404. If i is not less than i_max, control is transferred to step 420.

At step 420, given that values of AE_TiLj for all possible scenarios (activity plans) have been calculated, the planning computer may identify and suggest the activity plan with the lowest AE_TiLj. In one or more embodiments, the planning computer may identify the activity plan with the lowest AE_TiLj through exhaustive search.

So, for each time slot Ti and each location Lj there may be a corresponding accumulated error AE_TiLj. The combination of Ti and Lj that yields the lowest AE_TiLj may correspond to the best scenario that satisfies most possible participants' interest. A zero value of the accumulated error may indicate a scenario that every entity (possible participant) can participate at time Ti and they all prefer the selected location Lj. More often, though, a non-zero AE may be the best the activity planning system can find and either some people cannot go or some people who can go do not like the place selected, or both.

In one or more embodiments, a different objective of planning the activity such as, for example, maximizing satisfaction of participants, maximizing the number of participants, and/or minimizing dissatisfaction of non-participants may be employed. In one or more embodiments, further constraints and/or information such as, for example, capacities of the possible locations, prices at the possible locations, limitation on costs, promotions at one or more possible locations, and/or weather forecast may be included in planning the activity.

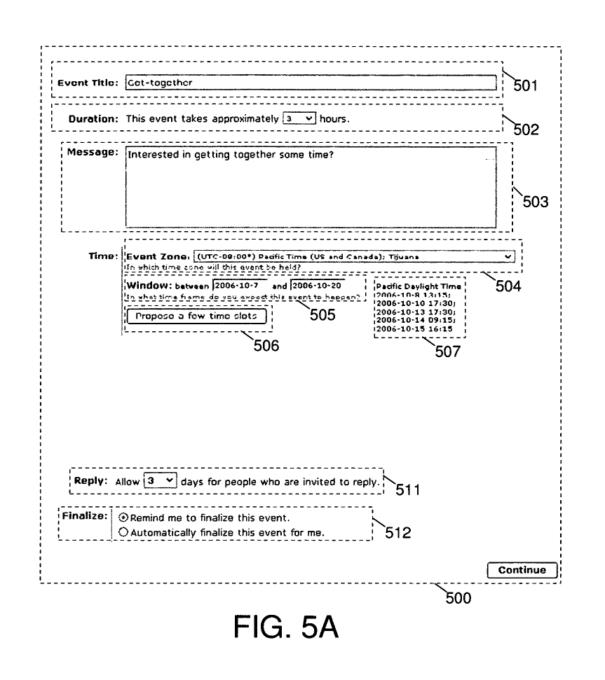

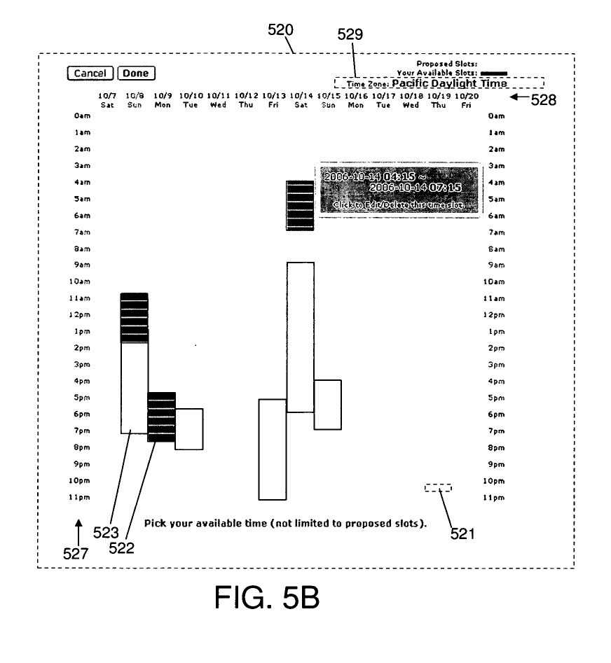

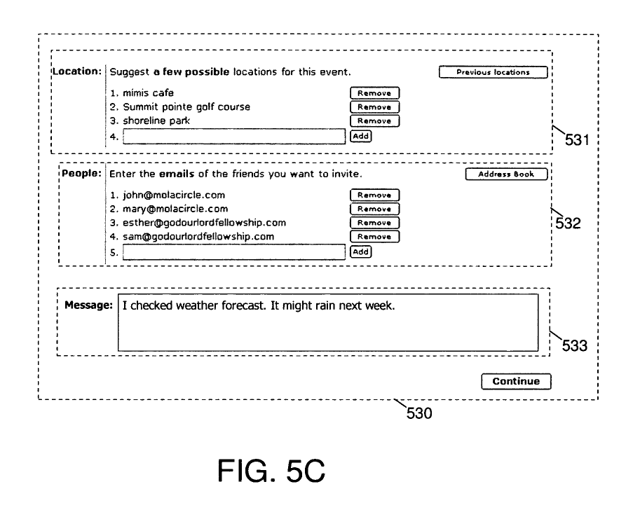

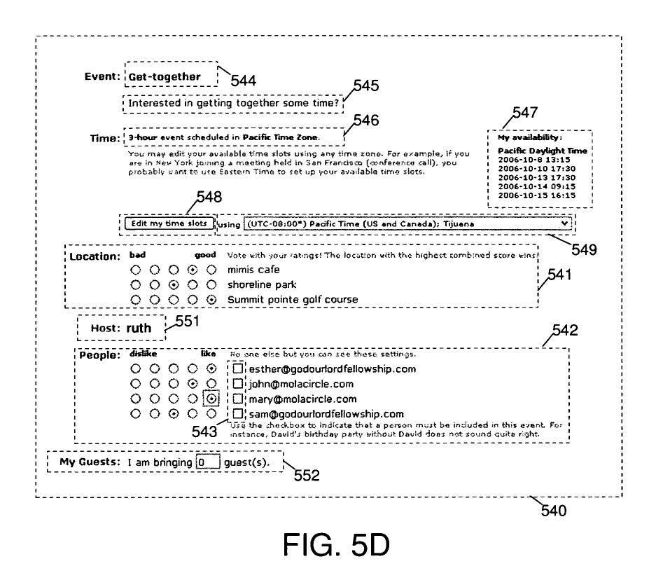

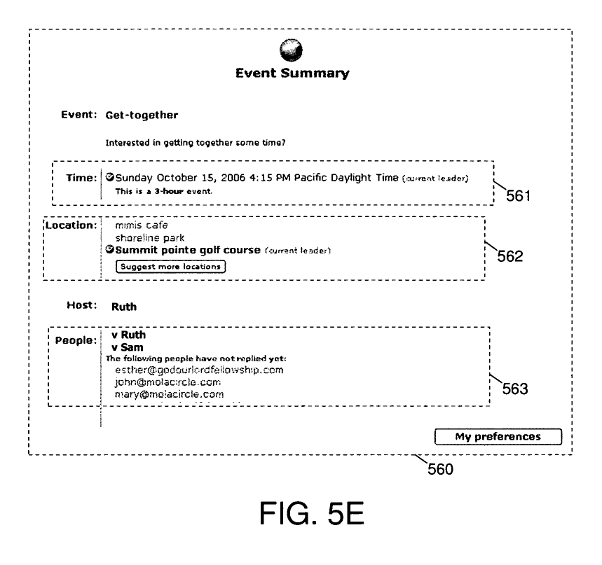

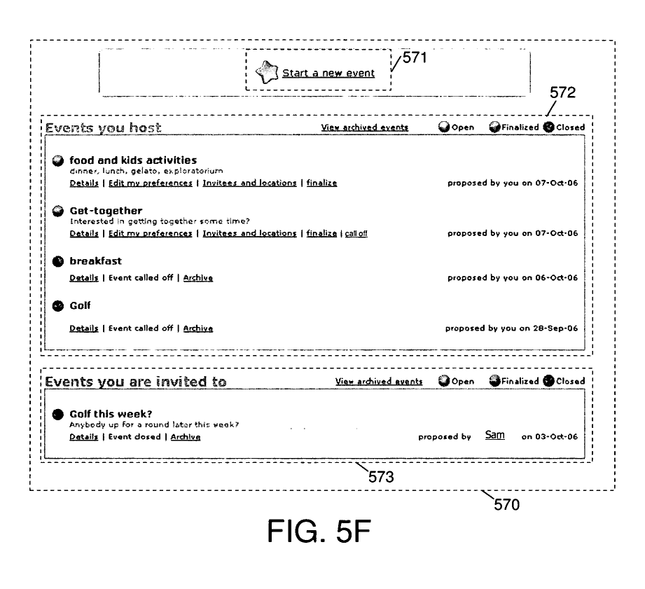

FIG. 5A shows a user interface 500 for receiving a suggestion for an activity (or event) from an initiator in accordance with one or more embodiments of the present invention. User interface 500 may include user interfaces 501, 502, 503, 504, 505, 506, 507, 511, and 512.

User interface 501 may be configured for receiving an event title. User interface 501 may include a text box that allows the initiator to enter the event title.

User interface 502 may be configured for receiving duration information of the activity. User interface 502 may include a pull-down menu that enables the initiator to select a duration, for example, in terms of number of hours.

User interface 503 may be configured for receiving a message pertaining to the event. User interface 503 may include an input box, such as a text box, that allows the initiator to enter a message. The message may be a text message. In one or more embodiments, the message may include audio, image, video, or multimedia content.

User interface 504 may be configured for receiving a time zone selection. For example, if the initiator is in New York when suggesting a lunch meeting in San Francisco next week, the initiator may find it convenient selecting the Pacific Time, or the time zone in which the lunch meeting will take place. If the initiator is in New York when suggesting a teleconference with colleagues in Taiwan, the initiator may find it convenient selecting the Eastern Time, or the time zone in which the initiator will participate in the teleconference. User interface 504 may include a pull-down menu for the initiator to select a time zone.

User interface 505 may be configured for receiving a time window for the event. User interface 505 may include a text box for the initiator to enter a start date for the time window and a text box for the initiator to enter an end date for the time window. Each of the text boxes for the start date and the end date may be configured to bring up an interactive calendar when being clicked on.

User interface 506 may be configured for receiving one or more time slots. User interface 506 may include a button configured to bring up an interactive calendar 520 shown in FIG. 5B and to be discussed below.

User interface 507 may be configured for displaying a set of time slots that include one or more time slots that have been input by the initiator. In one or more embodiments, user interface may be further configured to enable the initiator to set priority or preferences for the one or more time slots.

User interface 511 may be configured for receiving a deadline or an allowed time period for invitees to reply to the suggestion. User interface 511 may include a pull-down menu that enables the initiator to select a time period, for example, in terms of number of days.

User interface 512 may be configured for receiving the initiator's selection regarding how the planning for the event should be finalized. User interface 512 may include radio buttons that enable the initiator to request planning computer 102 (shown in FIG. 1) to send a reminder, e.g., through email or another communication means, for manually finalizing planning the event or to request planning computer 102 to automatically finalize planning the event, for example, utilizing the algorithm discussed with reference to FIG. 4.

FIG. 5B shows an interactive calendar 520 for receiving one or more time slots in accordance with one or more embodiments of the present invention. Interactive calendar 520 may be configured to be brought up when a user (i.e., the initiator or an invitee of the event/activity) click on a button for proposing or editing time slots such as the button in user interface 506 shown in FIG. 5A.

Interactive calendar 520 may include dates 528 and times 527. Interactive calendar 520 may include time units such as, for example, time unit 521. Each time unit may represent a certain time period such as, for example, 10:30 pm-11:00 pm on October 19, (Thursday) represented by time unit 521. The length (or granularity) of the time period may be configurable by the user. Interactive calendar 520 may enable a user to select a time slot by clicking on a time unit. The length of the time slot may be automatically configured to the duration input by the initiator, for example, through user interface 502 shown in FIG. 5A. For example, if the duration is set to be three hours, clicking on a time unit representing 5:00 pm-5:30 pm on October 9 (Monday) may cause time slot 522, representing 5:00 pm-8:00 pm on October 9, to be selected. Interactive calendar 520 may also enable the user to delete or edit the time slot by clicking on the time slot. Interactive calendar 520 may also enable the user to select a time slot by dragging through multiple time units.

Interactive calendar 5B may also display time slots that have been proposed by the initiator such as, for example, time slot 523. Time slots proposed by the initiator and time slots selected by the user may be displayed visually differently, for example, in different colors or patterns.

Interactive calendar 5B may also display time zone 529 received from user interface 504 shown in the example of FIG. 5A.

FIG. 5C shows a user interface 530 for receiving information pertaining to locations and people (possible participants for the activity) from a user (i.e., the initiator or an invitee) in accordance with one or more embodiments of the present invention. User interface 530 may include user interfaces 531, 532, and 533.

User interface 531 may be configured for receiving information pertaining to locations for the event such as, for example, location names and/or addresses. User interface 531 may include a text box that enables the user to add location information. User interface 531 may also be configured to enable the user to remove locations, for example, by clicking on “remove” buttons or to add locations stored in database 104 (shown in FIG. 1), for example, by clicking on a “previous locations” button. In one or more embodiments, only the initiator is allowed to remove locations.

User interface 532 may be configured for receiving (identification) information pertaining to people (or invitees) for the event such as, for example, usernames, names, and/or addresses. User interface 532 may include a text box that enables the user to add people information. User interface 532 may also be configured to enable the user to remove people, for example, by clicking on “remove” buttons or to add people stored in database 104 (shown in FIG. 1), for example, by clicking on an “address book” button. In one or more embodiments, user interface 532 may be available only to the initiator. In one or embodiments, the initiator and/or an invitee that is set (by the initiator) to be a priority possible participant for the event may not be removed.

User interface 533 may be configured to receive a message from the user. User interface 533 may include an input box, such as a text box, that allows the initiator to enter a message. The message may be a text message. In one or more embodiments, the message may include audio, image, video, or multimedia content. The message may be made available to possible participants, including the initiator, invitees, and guests. The message may be displayed when a possible participant mouses over to an identification (e.g., username, name, or email address) of the user on a Web browser user interface.

FIG. 5D shows a user interface 540 for receiving, from a user (e.g., the initiator or an invitee), preference data including data pertaining to time, locations, and people in accordance with one or more embodiments of the present invention. User interface 540 may include user interfaces 544, 545, 546, 547, 548, 549, 541, 551, 542, 543, and 552.

User interface 544 may be configured for displaying the activity/event title that has been input by the initiator, for example, through user interface 501 shown in FIG. 5A.

User interface 545 may be configured for displaying the message that has been input by the initiator, for example, through user interface 503 shown in FIG. 5A.

User interface 546 may be configured for displaying the duration and the time zone that has been input by the initiator, for example, through user interfaces 502 and 504 shown in FIG. 5A.

User interface 549 may be configured for receiving a time zone selection. User interface 549 may include a pull-down menu for the user to select a time zone.

User interface 548 may be configured for receiving one or more time slots selected or input by the user. User interface 548 may include a button configured to bring up an interactive calendar 520 shown in FIG. 5B as discussed above.

User interface 547 may be configured for displaying a set of time slots that include one or more time slots that have been selected or input by the user. In one or more embodiments, user interface may be further configured to enable the user to set priority or preferences of the one or more time slots.

User interface 541 may be configured for receiving data pertaining to the user's opinion(s) regarding one or more locations suggested by possible participants for the activity, including the initiator and invitees invited by the initiator. User interface 541 may include radio buttons that enable the user to make a selection, for example, in a scale ranging from “bad” to “good”, that represents the user's opinion regarding a location. The selection or a default selection (if the user does not make a selection) may be assigned a score for planning the activity, for example, by planning computer 102 (shown in FIG. 1). The default selection may represent a neutral opinion.

User interface 551 may be configured to display an identification of the initiator such as, for example, a username, name, or email address of the initiator.

User interface 542 may be configured for receiving data pertaining to the user's attitude(s) toward one or more possible participants (or people) for the activity, including the initiator and invitees invited by the initiator. User interface 542 may include radio buttons that enable the user to make a selection, for example, in a scale ranging from “dislike” to “like”, that represents the user's attitude toward a possible participant. The selection or a default selection (if the user does not make a selection) may be assigned a score for planning the activity, for example, by planning computer 102 (shown in FIG. 1). The default selection may represent a neutral attitude.

User interface 543 may be configured for receiving indication or designation of one or more priority possible participants for the activity. The one or more priority possible participants may represent one or more possible participants that must be included in the activity. For example, a birthday girl/boy should be a priority possible participant if the activity to be planned is a birthday party for the birthday girl/boy. In one or more embodiments, the priority possible participants and corresponding preference data may be assigned high scores or may be set as constraints for planning the activity. User interface 543 may include check boxes for the user to enter the indication. In one or more embodiments, user interface 543 is available only to the initiator. In one or more embodiments, availability of user interface 543 (to the invitees) may be determined by the initiator.

User interface 552 may be configured for receiving a number of guest(s) that the user would bring along to the activity (or event).

FIG. 5E shows a user interface 560 for presenting the status of planning an activity (or event) and/or an activity (or event) plan in accordance with one or more embodiments of the present invention. User interface 560 may include user interfaces 561, 562, and 563.

User interface 561 may be configured for presenting a suggested time slot for the activity. If the activity plan is not yet finalized, user interface 561 may indicate that the suggested time slot is the current leader among possible time slots for the activity. In one or more embodiments, user interface 561 may further present one or more back-up time slots that may be inferior to the suggested time slot according to an objective of planning the activity. The objective may be, for example, minimizing aggregated dissatisfaction (e.g., deviation from maximum aggregated scores representing preference data) of possible participants or maximizing aggregated satisfaction (e.g., a function of scores representing preference data) of possible participants.

User interface 562 may be configured for presenting a suggested location for the activity. If the activity plan is not yet finalized, user interface 562 may indicate that the suggested location is the current leader among possible locations for the activity. In one or more embodiments, user interface 562 may further present one or more back-up locations that may be inferior to the suggested time slot according to an objective of planning the activity. User interface 562 may be configured to provide a hyperlink (a button) for enabling the user to suggest more locations when the activity plan is not yet finalized.

User interface 563 may be configured for presenting a list of suggested participants for the activity. User interface 563 may be configured to present a list of possible participants that have not replied and/or a list of possible participants that will not attend the activity.

User interface 560 may further provide a hyperlink (a button) that enables the user to edit the user's preference data.

FIG. 5F shows a user interface 570 for a user to manage activities (or events) in accordance with one or more embodiments of the present invention. User interface 570 may include user interfaces 571, 572, and 573.

User interface 571 may be configured for providing a hyperlink to user interface 500 (shown in FIG. 5A) for enabling the user to initiate (or suggest) and activity.

User interface 572 may be configured for enabling the user to manage activities that have been initiated by the user. User interface 572 may include hyperlinks for enabling the user to view status and details of one or more activities, to edit the user's preference data for one or more activities, to view and edit invitees and locations for one or more activities, to finalize planning the time, location, and participants for one or more activities, to cancel one or more activities, and/or to archive information pertaining to one or more activities (that have been cancelled or closed). User interface 572 may enable the user to archive information pertaining to one or more activities such that archived activities are not shown in user interface 572 but are shown in a different user interface for archived activities.

User interface 573 may be configured for enabling the user to manage activities initiated by others for which the user has been invited. User interface 573 may include hyperlinks for facilitating the user to view status and details of one or more activities, to edit the user's preference data for one or more activities, and/or to archive information pertaining to one or more activities. User interface 573 may also be configured to provide one or more hyperlinks for facilitating the user to contact one or more initiators of one or more activities.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

What is claimed is:

1. A computer-implemented method for planning an activity, the computer-implemented method comprising:
receiving a suggestion pertaining to the activity, the suggestion provided by an initiator;
receiving a list of invitees, the list of invitees including at least two invitees; and
executing a decision program, using input data, to generate an activity plan,
wherein the input data includes at least one of initiator preference data and invitee preference data,
the initiator preference data pertains to preferences of the initiator,
the invitee preference data pertains to preferences of at least one invitee, the at least one invitee being among the invitees, and
the activity plan includes at least one of a list of suggested participants for the activity, a recommended time slot for the activity, and a recommended location for the activity.

2. The computer-implemented method of claim 1 wherein the initiator preference data includes data pertaining to the initiator's attitude toward one or more of the invitees.

3. The computer-implemented method of claim 1 wherein the invitee preference data includes data pertaining to the at least one invitee's attitude toward at least one of possible participants of the activity, the possible participants of the activity including the initiator and the invitees.

4. The computer-implemented method of claim 1 further comprising receiving designation of at least one priority possible participant, the designation of the at least one priority invitee being provided by the initiator, the at least one priority possible participant being selected from the initiator and the invitees, wherein the decision program prioritizes preferences of the at least one priority possible participant in generating the activity plan.

5. The computer-implemented method of claim 1 further comprising providing time zone selections to the initiator.

6. The computer-implemented method of claim 1 further comprising receiving time zone data, the time zone data pertains to the time zone of a location for the activity.

7. The computer-implemented method of claim 1 further comprising providing time zone selections to the invitees.

8. The computer-implemented method of claim 1 wherein the initiator preference data includes at least one possible time slot for the activity.

9. The computer-implemented method of claim 1 wherein the initiator preference data includes a plurality of possible time slots for the activity.

10. The computer-implemented method of claim 1 wherein the initiator preference data includes data pertaining to the initiator's preferences regarding a plurality of possible time slots for the activity.

11. The computer-implemented method of claim 1 wherein the invitee preference data includes at least one possible time slot for the activity.

12. The computer-implemented method of claim 1 wherein the invitee preference data includes data pertaining to the at least one invitee's preferences regarding a plurality of possible time slots for the activity.

13. The computer-implemented method of claim 1 wherein the activity plan includes a recommended time slot for the activity.

14. The computer-implemented method of claim 1 wherein the initiator preference data includes data pertaining to one or more possible locations for the activity.

15. The computer-implemented method of claim 1 wherein the initiator preference data includes data pertaining to the initiator's opinion regarding at least one possible location for the activity.

16. The computer-implemented method of claim 1 wherein the invitee preference data includes data pertaining to one or more possible locations for the activity.

17. The computer-implemented method of claim 1 wherein the invitee preference data includes data pertaining to the at least one invitee's opinion regarding at least one possible location for the activity.

18. The computer-implemented method of claim 1 wherein the activity plan includes a recommended location for the activity.

19. The computer-implemented method of claim 1 further comprising:
receiving one or more invitee messages provided by one or more of the invitees; and
displaying the one or more invitee messages to at least one of the initiator and one or more of the invitees.

20. The computer-implemented method of claim 1 further comprising reminding the initiator to finalize planning the activity with the activity plan.

21. The computer-implemented method of claim 1 further comprising:
automatically finalizing planning the activity by setting the activity plan as a finalized activity plan; and
informing at least one of the initiator and one or more of the invitees of the finalized activity plan.

22. The computer-implemented method of claim 1 further comprising archiving information pertaining to one or more past activities.

23. The computer-implemented method of claim 1 further comprising:
receiving an instruction from the initiator for canceling the activity; and
informing the invitees of cancellation of the activity.

24. The computer-implemented method of claim 1 further comprising assigning scores for the initiator and the invitees based on the initiator preference data and the invitee preference data.

25. The computer-implemented method of claim 1 further comprising assigning scores for possible time slots for the activity based on the initiator preference data and the invitee preference data.

26. The computer-implemented method of claim 1 further comprising assigning scores for possible locations for the activity based on the initiator preference data and the invitee preference data.

27. The computer-implemented method of claim 1 wherein the decision program is configured to implement at least one optimization algorithm.

28. The computer-implemented method of claim 1 wherein the decision program is configured to implement at least one of a linear programming algorithm, a nonlinear programming algorithm, a weighted scoring scheme, and an exhaustive search algorithm.

29. The computer-implemented method of claim 1 wherein the decision program is configured to interact with an optimization program.

30. The computer-implemented method of claim 1 wherein the input data further includes at least one of capacity information, promotion information, and price information pertaining to at least one possible location for the activity.

31. The computer-implemented method of claim 1 wherein the input data includes an objective for the planning the activity.

32. The computer-implemented method of claim 31 wherein the objective represents at least one of maximizing the number of the suggested participants, maximizing an aggregated utility function of the possible participants, maximizing an aggregated utility function of the suggested participants, maximizing an aggregated utility function of the possible participants excluding the suggested participants, minimizing deviation from a maximum aggregated utility value of the possible participants, minimizing deviation from a maximum aggregated utility value of the suggested participants, and minimizing deviation from a maximum aggregated utility value of the possible participants excluding the suggested participants.

33. The computer-implemented method of claim 31 further comprising generating at least one back-up activity plan using the input data, the at least one back-up activity plan being less desirable than the activity plan according to the objective.

34. The computer-implemented method of claim 1 further comprising recommending a plurality of objectives for the planning the activity.

35. The computer-implemented method of claim 1 further comprising receiving a plurality of objectives for planning the activity.

36. The computer-implemented method of claim 1 comprising:
generating a plurality of activity plans according a plurality of objectives for the planning the activity; and
presenting the plurality of activity plans to the initiator simultaneously.

37. The computer-implemented method of claim 1 wherein the input data further includes data pertaining to preferences of one or more guests invited by one or more of the invitees.

38. The computer-implemented method of claim 1 further comprising providing a mechanism for the initiator to control disclosure of the initiator preference data.

39. The computer-implemented method of claim 1 further comprising providing a mechanism for the at least one invitee to control disclosure of preference data of the at least one invitee.

40. The computer-implemented method of claim 1 further comprising notifying the invitees of the suggestion.

41. The computer-implemented method of claim 1 wherein the suggestion includes at least one of a location, a time window, a duration, and a message pertaining to the activity.

42. A system for planning an activity comprising:
a database; and
a computing device that is connected with the database and is configured to:
receive a suggestion pertaining to the activity, the suggestion provided by an initiator;
receive a list of invitees, the list of invitees including at least two invitees; and
execute a decision program, using input data, to generate an activity plan,
wherein the input data includes at least one of initiator preference data and invitee preference data,
the initiator preference data pertains to preferences of the initiator,
the invitee preference data pertains to preferences of at least one invitee, the at least one invitee being among the invitees,
the input data being provided by at least one of the database, the initiator, and the at least one invitee, and
the activity plan includes at least one of a list of suggested participants for the activity, a recommended time slot for the activity, and a recommended location for the activity.

43. The system of claim 42 wherein the initiator preference data includes data pertaining to the initiator's attitude toward one or more of the invitees.

44. The system of claim 42 wherein the invitee preference data includes data pertaining to the at least one invitee's attitude toward at least one of possible participants of the activity, the possible participants of the activity including the initiator and the invitees.

45. The system of claim 42 wherein the initiator preference data includes at least one initiator-preferred time slot for the activity, the invitee preference data includes at least one invitee-preferred time slot for the activity, and the activity plan includes a recommended time slot for the activity.

46. The system of claim 42 wherein the initiator preference data includes data pertaining to at least one initiator-preferred location for the activity, the invitee preference data includes data pertaining to at least one invitee-preferred location for the activity, and the activity plan includes a recommended location for the activity.

47. An article of manufacture comprising a program storage medium configured to store computer readable code for:
receiving a suggestion pertaining to the activity, the suggestion provided by an initiator;
receiving a list of invitees, the list of invitees including at least two invitees; and
executing a decision program, using input data, to generate an activity plan,
wherein the input data includes at least one of initiator preference data and invitee preference data,
the initiator preference data pertains to preferences of the initiator,
the invitee preference data pertains to preferences of at least one invitee, the at least one invitee being among the invitees, and
the activity plan includes at least one of a list of suggested participants for the activity, a recommended time slot for the activity, and a recommended location for the activity.

48. The article of manufacture of claim 47 wherein the initiator preference data includes data pertaining to the initiator's attitude toward one or more of the invitees.

49. The article of manufacture of claim 47 wherein the invitee preference data includes data pertaining to the at least one invitee's attitude toward at least one of possible participants of the activity, the possible participants of the activity including the initiator and the invitees.

50. The article of manufacture of claim 47 wherein the initiator preference data includes at least one initiator-preferred time slot for the activity, the invitee preference data includes at least one invitee-preferred time slot for the activity, and the activity plan includes a recommended time slot for the activity.

51. The article of manufacture of claim 47 wherein the initiator preference data includes data pertaining to at least one initiator-preferred location for the activity, the invitee preference data includes data pertaining to at least one invitee-preferred location for the activity, and the activity plan includes a recommended location for the activity.
